(19) United States
(12) Patent Application Publication
(10) Pub. No.: US 2015/0100808 A1
(43) Pub. Date: Apr. 9, 2015

(54) WAKEUP METHOD AND SYSTEM FOR TOUCH TERMINAL AND TOUCH TERMINAL

(71) Applicant: SHENZHEN HUIDING TECHNOLOGY CO., LTD., Shenzhen, Guangdong (CN)

(72) Inventor: Gengchun Deng, Shenzhen (CN)

(73) Assignee: SHENZHEN HUIDING TECHNOLOGY CO., LTD

(21) Appl. No.: 14/402,316

(22) PCT Filed: Oct. 22, 2013
(86) PCT No.: PCT/CN2013/085732

§ 371 Date: Nov. 20, 2014

(30) Foreign Application Priority Data
Dec. 27, 2012 (CN) 201210576518.0

(51) Int. Cl. G06F 1/32; G06F 3/041; G06F 21/31

(52) U.S. Cl. CPC G06F 1/3262; G06F 21/31; G06F 3/0416
USPC 713/323

(57) ABSTRACT

The present invention, relating to a technical field of touch control, provides a wakeup method and system for touch terminal and touch terminal. The method comprises the following steps: step a: scanning a touch screen, and detecting a touch action in a standby state; and step b: waking up the touch screen if a touch action which is consistent with a preset screen wakeup password is detected. The present invention also provides a system for screen wakeup of a touch terminal and a touch terminal. In the present invention, the screen wakeup of the touch terminal can be realized without the need of setting a mechanical key in the touch terminal, thus the lifetime of the touch terminal would not be impacted and the appearance of the touch terminal is also more attractive.

### TECHNICAL FIELD

The present invention relates to a technical field of touch control, and in particularly, to a touch terminal and method and system for screen wakeup thereof.

### BACKGROUND

Touch screen technology provides a convenient human-machine interaction manner to a user, and is favored by consumers. Therefore, it is also applied to various electronic products more and more frequently.

Due to consideration of electricity saving, in a standby state, each current electronic product in which a touch screen is applied would shut down the touch screen, i.e., stop detecting a touch operation of the user, and the user needs a mechanical key to wake up system, and then performs touch unlock during usage. The setting of the mechanical key impacts the attractive appearance of the overall machine in one aspect, and in another aspect, the mechanical key is a part easy to be destroyed, which impacts the lifetime of the machine.

### SUMMARY

The present invention provides a touch terminal and method and system for screen wakeup thereof, and is to solve the problem that a mechanical key is needed to be set to process screen wakeup in the prior art.

The present invention employs the following technical solution:

A method for screen wakeup of a touch terminal, comprising the following steps:

step a: scanning a touch screen, and detecting a touch action in a standby state;

step b: waking up the touch screen if the touch action which is consistent with a preset screen wakeup password is detected.

The present invention also provides a system for screen wakeup of a touch terminal, comprising:

a touch action detection module, for scanning a touch screen, and detecting a touch action in a standby state;

a wakeup module, for waking up the touch screen if the touch action detection module detects a touch action which is consistent with a preset screen wakeup password.

The present invention also provides a touch terminal, and the screen wakeup system as described above in the touch terminal.

The advantage effect of the present invention lies in that: in the present invention, the touch screen is scanned in the standby state, and the touch screen is waked up when the touch action which is consistent with the preset screen wakeup password is detected; therefore, the screen wakeup of the touch terminal can be realized without the need of setting the mechanical key in the touch terminal. Thus the lifetime of the touch terminal would not be impacted, and the appearance of the touch terminal is also more attractive.

### BRIEF DESCRIPTION OF THE DRAWINGS

FIG. 1 is a flowchart of realizing a method for screen wakeup of a touch terminal provided in the embodiment 1 of the present invention;

FIG. 2 is a schematic diagram of a wakeup action when a screen wakeup password is a Chinese character in the embodiment of the present invention;

FIG. 3 is a schematic diagram of a wakeup action when a screen wakeup password is a capital letter in the embodiment of the present invention;

FIG. 4 is a schematic diagram of a wakeup action when a screen wakeup password is a small letter in the embodiment of the present invention;

FIG. 5 is a schematic diagram of a wakeup action when a screen wakeup password is a stroke in the embodiment of the present invention;

FIG. 6 is a flowchart of realizing a method for screen wakeup of a touch terminal provided by the embodiment 2 of the present invention;

FIG. 7 is a structure block diagram of a system for screen wakeup of a touch terminal provided by the embodiment 3 of the present invention;

FIG. 8 is a structure block diagram of a system for screen wakeup of the touch terminal provided by the embodiment 4 of the present invention;

FIG. 9 is a schematic diagram of state transition of a touch terminal applied in the embodiments 3 and 4 of the present invention;

FIG. 10 is another schematic diagram of state transition of a touch terminal applied in the embodiments 3 and 4 of the present invention.

### DETAILED DESCRIPTION

For the sake of making the purpose, the technical solution and advantages of the present invention more clarity and obvious, the further detailed description to the present invention is given with reference to the drawings and embodiments below. It should be understood that the detailed embodiments described herein are only used to explain the present invention and is not used to limit the present invention.

In the embodiments of the present invention, a touch screen is scanned in a standby state, and the touch screen is waken up when a touch action which is consistent with a preset screen wakeup password is detected; therefore, the screen wakeup of a touch terminal can be realized without the need of setting a mechanical key in the touch terminal. Thus, the lifetime of the touch terminal would not be impacted, and the appearance of the touch terminal is also more attractive.

### Embodiment 1

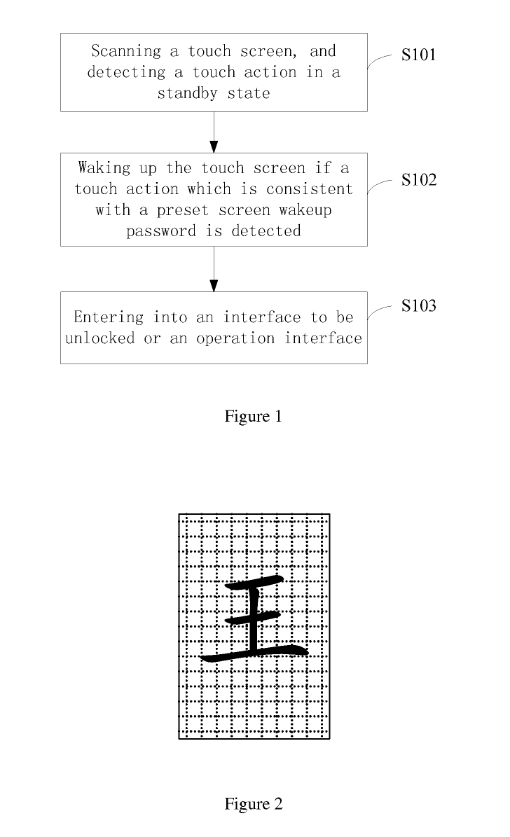

The embodiment 1 of the present invention provides a method for screen wakeup of a touch terminal. As shown in FIG. 1, the method comprises the following steps:

Step S101: scanning a touch screen, and detecting a touch action in a standby state;

In the present embodiment, the touch screen may be scanned in a wakeup scanning frequency in the standby state, wherein the wakeup scanning frequency may employ a low frequency to achieve the effect of electricity and energy saving, and realize low power consumption wakeup of the touch screen. Therefore, a scanning frequency which is lower than a scanning frequency in a normal working state of the touch terminal is specially set as the wakeup scanning frequency in the present embodiment.

In a preferred embodiment, the touch screen is scanned in a first scanning frequency, and whether sampled data for the touch screen changes or not is detected in the standby state; and if a change of the sampled data from the touch screen is detected, and the characteristic of the sampled data is judged to be similar to finger touch, then the touch screen is scanned in a second scanning frequency, and the touch action is detected. Because after the change of the sampled data from the touch screen is detected, it is possible that a user is trying to wake up the touch screen, and for enabling to detect whether the touch action of the user is consistent with a preset screen wakeup password correctly and completely, the scanning frequency is needed to be increased. For taking account of realizing the effect of electricity and energy saving, the second scanning frequency is higher than the first scanning frequency and lower than the scanning frequency in a normal working state at this time, that is, both the first scanning frequency and the second scanning frequency are lower than the scanning frequency when the touch terminal works normally, and the first scanning frequency is lower than the second scanning frequency. Or, the first scanning frequency is lower than the scanning frequency when the touch terminal works normally, while the second scanning frequency is the same as the scanning frequency when the touch terminal works normally.

Step S102: if a touch action which is consistent with a preset screen wakeup password is detected, then waking up the touch screen.

In the present embodiment, if the touch action which is consistent with the preset screen wakeup password is detected, it means that the user needs to wake up the touch screen. At this time, in addition to waking up the touch screen, the scanning frequency is also adjusted to the scanning frequency in a normal working state of the touch terminal, in order that the touch terminal realizes to scan for the normal working of the touch screen.

The screen wakeup password may be one of a Chinese character, letter or stock, or a combination of at least two of them, and may be set flexibly according to an actual situation. Now giving the example as follows:

(1) As shown in FIG. 2, when the screen wakeup password is the Chinese character, for example, the Chinese character “ [symbol] ” is preset to be the screen wakeup password, the subscriber (i.e. the user) inputs the Chinese character “ [symbol] ” on the standby screen, and the touch terminal analyzes and judges the inputted Chinese character, and if the Chinese character inputted by the subscriber is consistent with the preset screen wakeup password Chinese character “ [symbol] ”, then the touch screen may be waken up.

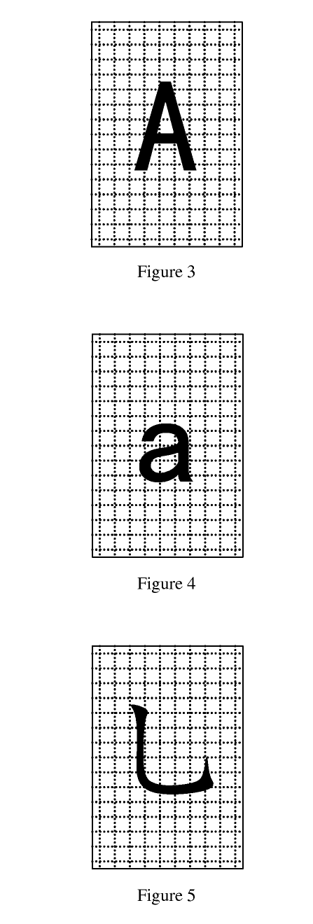

(2) As shown in FIG. 3, when the screen wakeup password is the letter, for example, a capital letter “A” is preset to be the screen wakeup password, the subscriber (i.e. the user) inputs the capital letter “A” on the standby screen, and the touch terminal analyzes and judges the inputted letter, and if the letter inputted by the subscriber is consistent with the preset screen wakeup password capital letter “A”, then the touch screen may be waken up.

(3) As shown in FIG. 4, when the screen wakeup password is the letter, for example, a small letter “a” is preset to be the screen wakeup password, the subscriber (i.e. the user) inputs the small letter “a” on the standby screen, and the touch terminal analyzes and judges the inputted letter, and if the letter inputted by the subscriber is consistent with the preset screen wakeup password small letter “a”, then the touch screen may be waken up.

(4) As shown in FIG. 5, when the screen wakeup password is the stroke having a certain meaning, for example, a stroke “ [symbol] ” is preset to be the screen wakeup password, the subscriber (i.e. the user) inputs the stroke “ [symbol] ” on the standby screen, and the touch terminal analyzes and judges the input stroke, and if the stroke inputted by the subscriber is consistent with the preset screen wakeup password stroke “ [symbol] ”, then the touch screen may be waken up.

Of course, it may also be a combination of the above-mentioned Chinese character, letter or stroke, for example, it is needed to input the Chinese character “ [symbol] ” and letter “A” successively, then the touch screen can be waken up. It will not be enumerated herein.

Step 103: entering into an interface to be unlocked or an operation interface.

In the present embodiment, the interface to be unlocked is an interface which needs the user to input an unlock password and only after the input, the screen operation can be processed. In other embodiments, according to user-defined settings, this step may also be entering into the operation interface in which the user can process the screen operation directly. Compared with the manner of entering into the operation interface, the manner of entering into the unlocked interface has a higher safety, but the user's operation is more complex.

An ordinary person skilled in the art may understand that the entire or a part of the steps implementing the method of the present embodiment can be accomplished by a program instructing related hardware, and the program may be stored in a computer readable storage medium, and the storage medium may adopts ROM/RAM, disk, compact disc, etc.

In the embodiment of the present invention, the touch screen is scanned in the standby state, and the touch screen is waken up when the touch action which is consistent with the preset screen wakeup password is detected; therefore, the screen wakeup of the touch terminal can be realized without the need of setting the mechanical key in the touch terminal. Thus, the lifetime of the touch terminal would not be impacted, and the appearance of the touch terminal is also more attractive. By presetting the screen wakeup password, the screen can only be waken up when the user inputs a correct screen wakeup password, and the safety is high. In addition, by employing the scanning frequency which is lower than the scanning frequency in the normal working state of the touch terminal as the wakeup scanning frequency, the electricity and the energy are saved and the low power consumption wakeup of the touch screen is realized.

### Embodiment 2

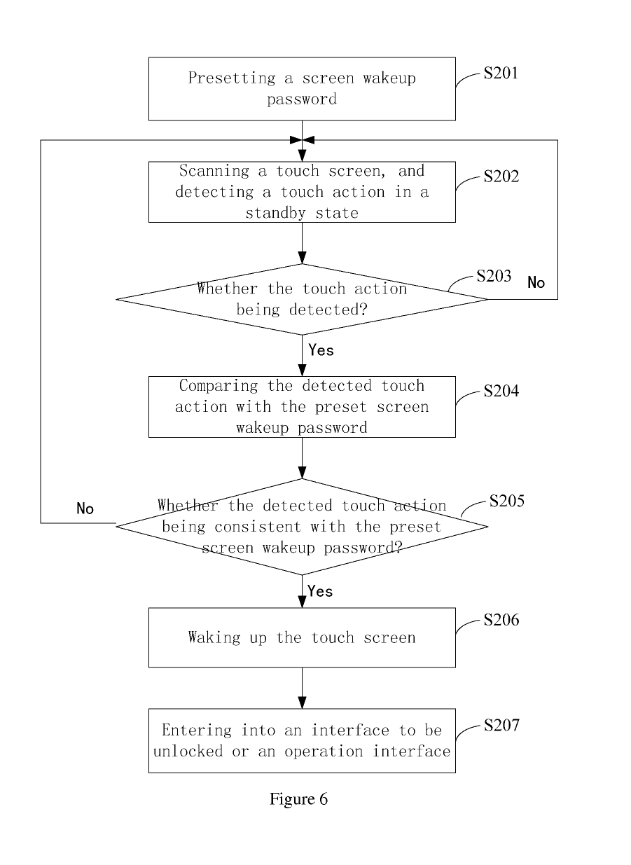

The embodiment 2 of the present invention provides a method for screen wakeup of a touch terminal. As shown in FIG. 6, the method comprises the following steps:

Step S201: presetting a screen wakeup password;

In the present embodiment, a touch action inputted by a user is received and preset as the screen wakeup password in a normal working state. Of course, this step is not necessarily processed only before the subsequent steps. During the user uses the touch terminal, if it is needed to set or modify the screen wakeup password again, the presetting or modification of the screen wakeup password may also be processed by performing this step.

Step S202: scanning the touch screen, and detecting the touch action in a standby state;

In the present embodiment, the touch screen may be scanned in an wakeup scanning frequency in the standby state, and the wakeup scanning frequency may employ a low frequency in order to achieve the effect of electricity and energy saving and realize the low power consumption wakeup of the touch screen. Therefore, in the present embodiment, a scanning frequency which is lower than the scanning frequency in the normal working state of the touch terminal is specially set as the wakeup scanning frequency.

In a preferred embodiment, the touch screen is scanned in a first scanning frequency, and whether sampled data for the touch screen changes or not is detected in the standby state; and if a change of the sampled data from the touch screen is detected, and the characteristic of the sampled data is judged to be similar to finger touch, then the touch screen is scanned in a second scanning frequency, and the touch action is detected, wherein both the first scanning frequency and the second scanning frequency are lower than the scanning frequency when the touch terminal works normally, and the first scanning frequency is lower than the second scanning frequency; or the first scanning frequency is lower than the scanning frequency when the touch terminal works normally, and the second scanning frequency is the same as the scanning frequency when the touch terminal works normally.

Step S203: judging whether the touch action is detected, and if so, performing step S204; otherwise, returning back to perform step S202;

Step S204: comparing the detected touch action with the preset screen wakeup password; The screen wakeup password may be one of a Chinese character, letter or stock, or a combination of at least two of them, and may be set flexibly according to an actual situation, which has been fully illustrated in the embodiment 1, and is omitted herein.

Step S205: judging whether the detected touch action is consistent with the preset screen wakeup password, and if so, performing step S206; otherwise, returning back to perform step S202;

In the present embodiment, if the touch action which is consistent with the preset screen wakeup password is detected, it means that the user needs to wake up the touch screen.

Step S206: waking up the touch screen;

In the present embodiment, at this time, in addition to waking up the touch screen, the scanning frequency is also adjusted to the scanning frequency in a normal working state of the touch terminal at the same time, in order that the touch terminal realizes to scan for the normal working of the touch screen.

Step 207: entering into an interface to be unlocked or an operation interface.

In the present embodiment, the interface to be unlocked is an interface which needs the user to input an unlock password and only after the input, the screen operation can be processed. In other embodiments, according to user-defined settings, this step may also be entering into the operation interface in which the user can process the screen operation directly. Compared with the manner of entering into the operation interface, the manner of entering into the unlocked interface has a higher safety, but the user's operation is more complex.

An ordinary person skilled in the art may understand that the entire or a part of the steps implementing the method of the present embodiment can be accomplished by a program instructing related hardware, and the program may be stored in a computer readable storage medium, and the storage medium may adopts ROM/RAM, disk, compact disc, etc.

By using the method provided by the present embodiment in the touch terminal, the screen wakeup of the touch terminal can be realized without the need of setting the mechanical key in the touch terminal. Thus, the lifetime of the touch terminal would not be impacted, and the appearance of the touch terminal is also more attractive.

### Embodiment 3

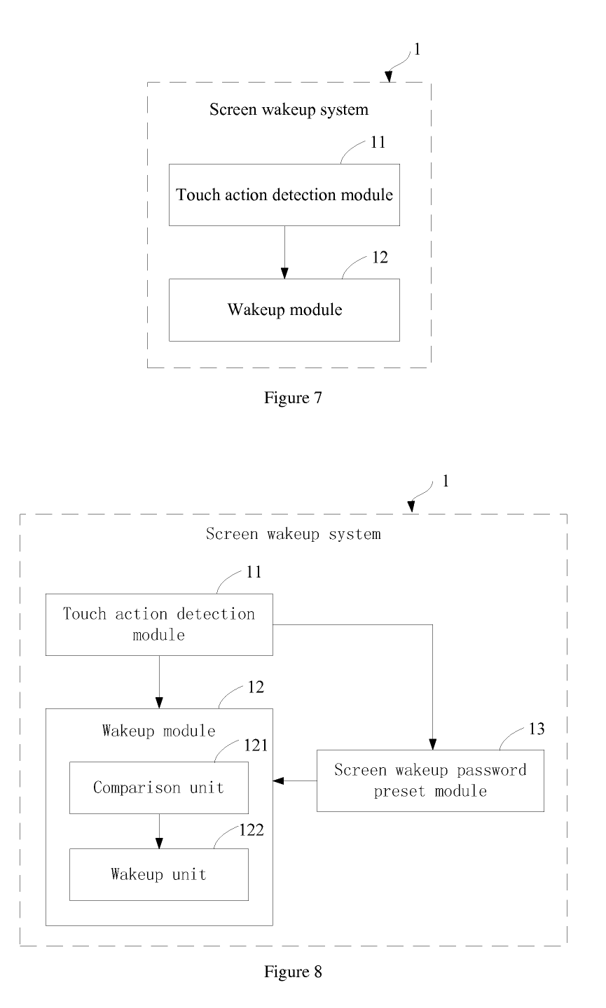

The embodiment 3 of the present invention provides a system for screen wakeup of a touch terminal. As shown in FIG. 7, for convenience of description, only the parts related to the embodiment of the present invention is shown. The entire or a part of the modules in this screen wakeup system may be set in the driving IC of the touch screen.

Please refer to FIG. 7, the screen wakeup system 1 comprises a touch action detection module 11 and an wakeup module 12. In a standby state, the touch action detection module 11 scans the touch screen and detects a touch action. In the present embodiment, the touch action detection module 11 may scan the touch screen in an wakeup scanning frequency in the standby state, and the wakeup scanning frequency may employ a low frequency in order to achieve the effect of electricity and energy saving and realize the low power consumption wakeup of the touch screen. Therefore, in the present embodiment, a scanning frequency which is lower than a scanning frequency in a normal working state of the touch terminal is specially set as the wakeup scanning frequency.

When the touch action detection module 11 detects a touch action which is consistent with a preset screen wakeup password, the wakeup module 12 wakes up the touch screen. In the present embodiment, if the touch action which is consistent with the preset screen wakeup password is detected, it means that a user needs to wake up the touch screen. At this time, in addition to wake up the touch screen, the wakeup module 12 also adjusts the scanning frequency to the scanning frequency in a normal working state of the touch terminal at the same time, so as to make the touch terminal realize to scan for the normal working of the touch screen. The screen wakeup password may be one of a Chinese character, letter or stock, or a combination of at least two of them, and may be set flexibly according to an actual situation, which has been fully illustrated in the embodiment 1, and is omitted herein.

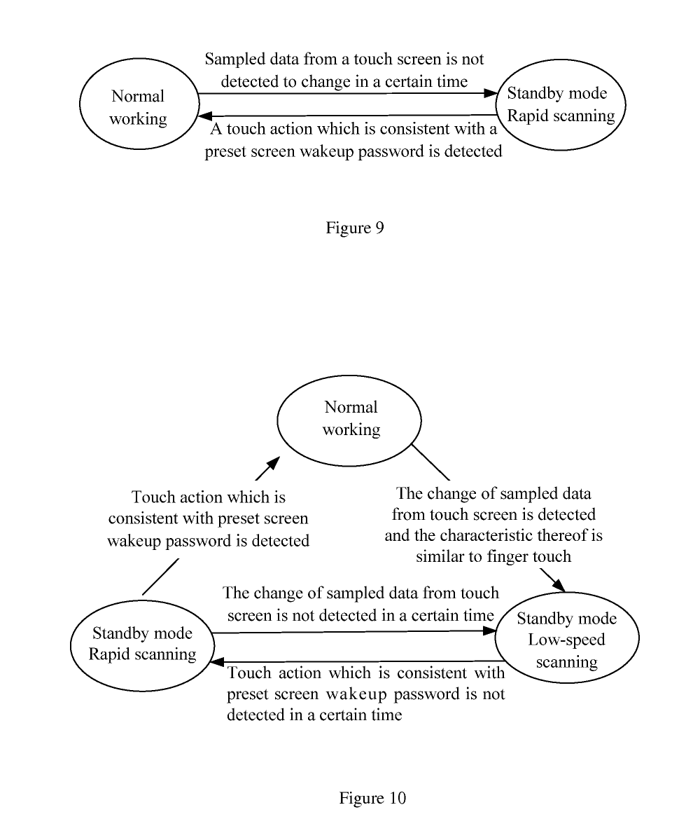

The above-mentioned wakeup system may be applied to various kinds of touch terminals, for example, a touch screen mobile phone, a touch tablet, a multimedia playing terminal having a touch screen function, self-serving smart terminal, etc. The entire conversion of the touch terminal between the standby state and the normal working state is shown as FIG. 9, wherein the rapid scanning is namely the scanning in the wakeup scanning frequency.

In a preferred embodiment, in the standby state, the touch action detection module 11 scans the touch screen in a first scanning frequency, and detects whether sampled data from the touch screen changes or not; and if a change of the sampled data from the touch screen is detected, and the characteristic of the sampled data is judged to be similar to finger touch, then the touch screen is scanned in a second scanning frequency, and the touch action is detected, wherein, both the first scanning frequency and the second scanning frequency are lower than the scanning frequency when the touch terminal works normally, and the first scanning frequency is lower than the second scanning frequency; or the first scanning frequency is lower than the scanning frequency when the touch terminal works normally, and the second scanning frequency is the same as the scanning frequency when the touch terminal works normally. When the wakeup system is applied to the touch terminal, the conversion of the touch terminal between the standby state and the normal working state is shown as FIG. 10, wherein the low speed scanning and the rapid scanning correspond to the first scanning frequency and the second scanning frequency.

After waking up the touch screen, the wakeup module 12 enters into an interface to be unlocked. In the present embodiment, the interface to be unlocked is an interface which needs the user to input an unlock password and only after the input, the screen operation can be processed. In other embodiments, according to the user-defined settings, the operation interface may also be entered into after the wakeup module 12 wakes up the touch screen, and the operation interface is the interface in which the user may process the screen operation directly. Compared with the manner of entering into the operation interface, the manner of entering into the unlocked interface has a higher safety, but the user's operation is more complex.

By using the screen wakeup system provided by the present embodiment in the touch terminal, the screen wakeup of the touch terminal can be realized without the need of setting a mechanical key in the touch terminal. Thus, the lifetime of the touch terminal would not be impacted, and the appearance of the touch terminal is more attractive.

### Embodiment 4

The embodiment 4 of the present invention provides a system for screen wakeup of a touch terminal. As shown in FIG. 8, for convenience of description, only the part related to the embodiment of the present invention is shown. The entire or a part of the modules in this screen wakeup system may be set in the driving IC of the touch screen.

Please refer to FIG. 8, a screen wakeup system 1 comprises a touch action detection module 11, an wakeup module 12 and a screen wakeup password preset module 13.

In a normal working state, the screen wakeup password preset module 13 receives a touch action inputted by a user, and presets the touch action as the screen wakeup password. The screen wakeup password preset module 13 may set the screen wakeup password by receiving the touch action detected by the touch action detection module 11. During the user uses the touch terminal, if the screen wakeup password is needed to be set or modified again, then the screen wakeup password is preset or modified by the screen wakeup password preset module 13.

In a standby state, the touch action detection module 11 scans the touch screen, and detects the touch action. In the present embodiment, the touch action detection module 11 may scan the touch screen in a wakeup scanning frequency in the standby state, and the wakeup scanning frequency may employ a low frequency so as to achieve the effect of electricity and energy saving, and realize the low power consumption wakeup of the touch screen. Therefore, in the present embodiment, a scanning frequency which is lower than the scanning frequency in a normal working state of the touch terminal is specially set as the wakeup scanning frequency. In the present embodiment, the wakeup module 12 comprises a comparison unit 121 and an wakeup unit 122. When the touch action detection module 11 detects a touch action which is consistent with the preset screen wakeup password, the comparison unit 121 compares the detected touch action with the screen wakeup password preset by the screen wakeup password preset module 13, and judges whether the detected touch action and the preset screen wakeup password are identical. The screen wakeup password may be one of a Chinese character, letter or stock, or a combination of at least two of them, and may be set according to an actual situation flexibly, which has been illustrated in detail in the embodiment 1 and is omitted herein. If the comparison unit 121 judges that the detected touch action is consistent with the preset screen wakeup password, it means that the user needs to wake up the touch screen, and at this time, the touch screen is waken up through the wakeup unit 122. In the present embodiment, at this time, in addition to waking up the touch screen, at the same time, the wakeup unit 122 also adjusts the scanning frequency to the scanning frequency in the normal working state of the touch terminal, in order that the touch terminal realizes to scan for the normal working of the touch screen.

After waking up the touch screen, the wakeup module 12 enters into an interface to be unlocked. In the present embodiment, the interface to be unlocked is an interface which needs the user to input an unlock password and only after the input, the screen operation can be processed. In other embodiments, according to the user-defined settings, the operation interface may also be entered into after the wakeup module 12 wakes up the touch screen, and the operation interface is the interface in which the screen operation can be processed by the user directly. Compared with the manner of entering into the operation interface, the manner of entering into the unlocked interface has a higher safety, but the user's operation is more complex.

The above-mentioned wakeup system may be applied to various kinds of touch terminals, for example, a touch screen mobile phone, a touch tablet, a multimedia playing terminal having a touch screen function, a self-serving smart terminal, etc. The entire conversion of the touch terminal between the standby state and the normal working state is shown as FIG. 9, wherein a rapid scanning is namely the scanning in a wakeup scanning frequency.

In a preferred embodiment, in the standby state, the touch action detection module 11 scans the touch screen in a first scanning frequency, and detects whether sampled data from the touch screen changes or not; and if a change of the sampled data from the touch screen is detected, and the characteristic of the sampled data is judged to be similar to finger touch, then the touch screen is scanned in a second scanning frequency, and the touch action is detected, wherein, both the first scanning frequency and the second scanning frequency are lower than the scanning frequency when the touch terminal works normally, and the first scanning frequency is lower than the second scanning frequency; or the first scanning frequency is lower than the scanning frequency when the touch terminal works normally, and the second scanning frequency is the same as the scanning frequency when the touch terminal works normally. When the wakeup system is applied to the touch terminal, the conversion of the touch terminal between the standby state and the normal working state is shown as FIG. 10, wherein the low speed scanning and the rapid scanning correspond to the first scanning frequency and the second scanning frequency.

By using the screen wakeup system provided by the present embodiment in the touch terminal, the screen wakeup of the touch terminal can be realized without the need of setting a mechanical key in the touch terminal. Thus, the lifetime of the touch terminal would not be impacted, and the appearance of the touch terminal is more attractive.

### Embodiment 5

The embodiment 5 of the present invention provides a touch terminal, and the screen wakeup system provided in the embodiment 3 or embodiment 4 is set in the touch terminal. The detailed working principle is as described above, which is omitted herein.

The touch terminal provided in the present embodiment can realize the screen wakeup of the touch terminal without the need of setting a mechanical key in the touch terminal. Thus, the lifetime of the touch terminal would not be impacted and the appearance of the touch terminal is also more attractive.

The above descriptions are merely preferred embodiments of the present invention, but are not intended to limit the present invention. Any modification, equivalent replacement, or improvement, and so on which are made without departing from the spirit and principle of the present invention should fall within the protection scope of the present invention.

1. A method for screen wakeup of a touch terminal, which is characterized in that the method comprises the following steps:
step a: scanning a touch screen, and detecting a touch action in a standby state;
step b: waking up the touch screen if a touch action which is consistent with a preset screen wakeup password is detected.

2. The method for screen wakeup of the touch terminal according to claim 1, which is characterized in that:
the step a specifically comprises:
step a1: scanning the touch screen in a first scanning frequency, and detecting whether sampled data from the touch screen changes or not in the standby state;
step a2: if a change of the sampled data from the touch screen is detected in the step al, and the characteristic of the sampled data is judged to be similar to finger touch, then scanning the touch screen in a second scanning frequency, and detecting the touch action;
specifically, the step b is:
waking up the touch screen, and adjusting the scanning frequency to a scanning frequency in a normal working state of the touch terminal at the same time if the touch action which is consistent with the preset screen wakeup password is detected;
wherein, both the first scanning frequency and the second scanning frequency are lower than the scanning frequency when the touch terminal works normally, and the first scanning frequency is lower than the second scanning frequency; or the first scanning frequency is lower than the scanning frequency when the touch terminal works normally, and the second scanning frequency is the same as the scanning frequency when the touch terminal works normally.

3. The method for screen wakeup of the touch terminal according to claim 1, which is characterized in that the method also comprises the following steps:
receiving the touch action inputted by a user in a normal working state, and presetting the touch action as the screen wakeup password.

4. The method for screen wakeup of the touch terminal according to claim 1, which is characterized in that:
specifically, the step a is: scanning the touch screen in an wakeup scanning frequency in the standby state;
specifically, the step b is: waking up the touch screen, and adjusting the scanning frequency to a scanning frequency in a normal working state of the touch terminal at the same time if the touch action which is consistent with the preset screen wakeup password is detected;
wherein, the wakeup scanning frequency is lower than the scanning frequency in the normal working state of the touch terminal.

5. The method for screen wakeup of the touch terminal according to claim 1, which is characterized in that the step b specifically comprises:
step b1: judging whether the touch action is detected;
step b2: comparing the detected touch action with the preset screen wakeup password if the touch action is detected;
step b3: waking up the touch screen when the touch action which is consistent with the preset screen wakeup password is detected.

6. The method for screen wakeup of the touch terminal according to claim 1, which is characterized in that after the step b, the method also comprises the following steps:
step c: entering into an interface to be unlocked or an operation interface;
wherein, the interface to be unlocked is an interface which needs a user to input an unlock password and only after the input, the screen operation can be processed, and the operation interface is an interface in which the user can process the screen operation directly.

7. The method for screen wakeup of the touch terminal according to claim 1, which is characterized in that the screen wakeup password is one of Chinese character, letter or stroke or a combination of at least two of them.

8. A system for screen wakeup of a touch terminal, which is characterized in that the system comprises:
a touch action detection module, for scanning a touch screen, and detecting a touch action in a standby state;
a wakeup module, for waking up the touch screen if a touch action which is consistent with a preset screen wakeup password is detected by the touch action detection module.

9. The system for screen wakeup of the touch terminal according to claim 8, which is characterized in that the system also comprises:
a screen wakeup password preset module, for receiving the touch action inputted by a user in a normal working state, and presetting the touch action as the screen wakeup password;
wherein the screen wakeup password is one of Chinese character, letter or stroke or a combination of at least two of them.

10. The system for screen wakeup of the touch terminal according to claim 8, which is characterized in that:
the touch action detection module scans the touch screen in a first scanning frequency in the standby state, and detects whether sampled data from the touch screen changes or not, and when a change of the sampled data from the touch screen is detected, and the characteristic of the sampled data is judged to be similar to finger touch, scans the touch screen in a second scanning frequency, and detects the touch action;
the wakeup module wakes up the touch screen, and adjusts the scanning frequency to a scanning frequency in a normal working state of the touch terminal at the same time if the touch action detection module detects the touch action which is consistent with the preset screen wakeup password;
wherein, both the first scanning frequency and the second scanning frequency are lower than the scanning frequency when the touch terminal works normally, and the first scanning frequency is lower than the second scanning frequency; or the first scanning frequency is lower than the scanning frequency when the touch terminal works normally, and the second scanning frequency is the same as the scanning frequency when the touch terminal works normally.

11. The system for screen wakeup of the touch terminal according to claim 8, which is characterized in that:
the touch action detection module scans the touch screen in an wakeup scanning frequency in the standby state;
the wakeup module wakes up the touch screen, and adjusts the scanning frequency to a scanning frequency in a normal working state of the touch terminal at the same time if the touch action detection module detects the touch action which is consistent with the preset screen wakeup password;
wherein, the wakeup scanning frequency is lower than the scanning frequency in a normal working state of the touch terminal.

12. A touch terminal, which is characterized in that: a screen wakeup system is set in the touch terminal; wherein the system comprises:
a touch action detection module, for scanning a touch screen, and detecting a touch action in a standby state;
a wakeup module, for waking up the touch screen if a touch action which is consistent with a preset screen wakeup password is detected by the touch action detection module.

13. The touch terminal according to claim 12, which is characterized in that the system also comprises:
a screen wakeup password preset module, for receiving the touch action inputted by a user in a normal working state, and presetting the touch action as the screen wakeup password;
wherein the screen wakeup password is one of Chinese character, letter or stroke or a combination of at least two of them.

14. The touch terminal according to claim 12, which is characterized in that:
the touch action detection module scans the touch screen in a first scanning frequency in the standby state, and detects whether sampled data from the touch screen changes or not, and when a change of the sampled data from the touch screen is detected, and the characteristic of the sampled data is judged to be similar to finger touch, scans the touch screen in a second scanning frequency, and detects the touch action;
the wakeup module wakes up the touch screen, and adjusts the scanning frequency to a scanning frequency in a normal working state of the touch terminal at the same time if the touch action detection module detects the touch action which is consistent with the preset screen wakeup password;
wherein, both the first scanning frequency and the second scanning frequency are lower than the scanning frequency when the touch terminal works normally, and the first scanning frequency is lower than the second scanning frequency; or the first scanning frequency is lower than the scanning frequency when the touch terminal works normally, and the second scanning frequency is the same as the scanning frequency when the touch terminal works normally.

15. The touch terminal according to claim 12, which is characterized in that:
the touch action detection module scans the touch screen in an wakeup scanning frequency in the standby state;
the wakeup module wakes up the touch screen, and adjusts the scanning frequency to a scanning frequency in a normal working state of the touch terminal at the same time if the touch action detection module detects the touch action which is consistent with the preset screen wakeup password;
wherein, the wakeup scanning frequency is lower than the scanning frequency in a normal working state of the touch terminal.
